(19) United States
(12) Patent Application Publication
(10) Pub. No.: US 2015/0002621 A1
(43) Pub. Date: Jan. 1, 2015

(54) Apparatus and Method for Acquiring Underwater Images

(71) Applicant: Google Inc., Mountain view, CA (US)

(72) Inventors: Daniel J. Ratner, San Francisco, CA (US); Iain R. McClatchie, Los Altos, CA (US); Alexander T. Starns, Menlo Park, CA (US)

(21) Appl. No.: 14/375,448

(22) PCT Filed: Jan. 25, 2013
(86) PCT No.: PCT/US13/23120

§ 371 Date: Jul. 30, 2014

Related U.S. Application Data
(60) Provisional application No. 61/592,362, filed on Jan. 30, 2012.

(51) Int. Cl. H04N 5/232; H04N 5/225

(52) U.S. Cl. CPC H04N 5/23238; H04N 5/2252
USPC 348/36

(57) ABSTRACT

Provided is a camera for capturing underwater panoramic views from a plurality of image locations along a path and data indicative of orientations and geographic locations of the camera at the image locations. The camera may include a water-proof housing and an image-capture module disposed at least partially in the water-proof housing and configured to capture a plurality of underwater images of visible light from a plurality of image locations along a path. The camera may also include a location sensor configured to obtain geographic locations of the plurality of image locations along the path, an orientation sensor configured to sense orientations of the image-capture module at the plurality of image locations along the path, and memory communicatively coupled to the image-capture module, and the location sensor, and the orientation sensor.

### BACKGROUND OF THE INVENTION

1. Field of the Invention

The present invention relates generally to image-acquisition and, more specifically, to techniques for acquiring underwater images.

2. Description of the Related Art

Mapping systems often include images of geographic areas offering different views. For example, some mapping systems provide to users images from a satellite view, images from an airplane view, and images from a street-level view or eye-level view. The images from these different views are often associated with data indicating the direction, or orientation, of the view and data indicating the geographic location depicted in the view or from which the view was captured. Based on this location and orientation data, mapping systems often stitch the images together to form larger views than depicted in individual images. The mapping systems also often present the images in a sequence or other arrangement based on the orientation and location data in response to user requests to view a different orientation or location from one currently being depicted by the mapping system. By entering a series of such requests, users may navigate along a path through a geographic area by viewing a sequence of images along that path and changing which orientation is depicted, thereby simulating the experience of a person traveling that path and looking around the geographic area.

Generally, many mapping systems do not include an underwater view in which images of underwater features are depicted with adequate quality. Capturing such images is often difficult because bubbles in the water interfere with image capture, underwater lighting is often insufficient, and labor costs associated with imaging a given geographic area are often relatively high because limited viewing distances underwater often require a camera person to raster a camera over an imaged geographic area a relatively high number of times in order to capture a comprehensive set of images of the area. Further, it is often difficult to obtain orientation and geographic location data indicating the orientation and location from which images are captured while capturing underwater images because of movement induced by the water, e.g., by waves, and attenuation of signals for determining location underwater.

### SUMMARY OF THE INVENTION

The following is a non-exhaustive listing of some aspects of the present techniques. These and other aspects are described in the following disclosure.

In some aspects, the present invention includes a camera for capturing underwater panoramic views from a plurality of image locations along a path and data indicative of orientations and geographic locations of the camera at the image locations. The camera of this aspect includes a water-proof housing and an image-capture module disposed at least partially in the water-proof housing and configured to capture a plurality of underwater images of visible light from a plurality of image locations along a path. The camera of this aspect also includes a location sensor configured to obtain geographic locations of the plurality of image locations along the path, an orientation sensor configured to sense orientations of the image-capture module at the plurality of image locations along the path, and memory communicatively coupled to the image-capture module, and the location sensor, and the orientation sensor.

Some aspects include an image-acquisition apparatus that includes an array of two or more water-craft each operable to transport a human operator, each water-craft mechanically coupled to another water-craft in the array of water-craft, and each water-craft having an image-capture module, the image capture module being operable to capture underwater images based on visible light and being operable to capture orientation data indicative of a spatial orientation of at least part of the image-capture module during image capture. Each image-capture module of this aspect includes one or more windows, at least part of which is disposed at a depth under a water-line of the corresponding water-craft. Further, each of the present image-capture modules includes two or more cameras operable to sense visible light, each camera having an optical axis that intersects at least one of the one or more windows, each optical axis being at an oblique angle to a plane defined by the water-line of the water-craft, and the two or more cameras being approximately radially symmetrically disposed about a normal to the horizontal plane, and an orientation sensor having zero degrees of freedom relative to the two or more cameras. At least one of the image-capture modules of the present aspect includes a geographic-position sensor operable to capture location data indicative of a geographic location of the array of water craft, the geographic-position sensor comprising an antenna disposed at least partially above the water-line of the water-craft; a power-supply operable to provide electrical power to at least one of the image-capture modules; and a one or more processors coupled to a tangible-machine readable memory storing instructions that when executed by one or more of the one or more processors cause each of a plurality of images captured by each image-capture module to be correlated to data from the orientation sensor indicative of orientations of the cameras at the time the image was captured and data from the geographic-position sensor indicative of the geographic location of the array of water-craft at the time the image was captured.

Some aspects include a method of imaging an underwater geographic area. The method of this aspect includes propelling a watercraft through water, capturing, with one or more cameras coupled to the watercraft, images of underwater features in field of view spanning an approximately 360-degree azimuth; sensing a geographic location of the watercraft; sensing an orientation of one or more of the one or more cameras; and storing the captured images, the sensed geographic location, and the sensed orientation in memory.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 illustrates an example of a image-capture module attached to an example of a watercraft;

FIG. 2 is a partially-exploded view of the image-capture module of FIG. 1;

FIG. 3 illustrates an example of an array of image-capture modules and watercraft;

FIGS. 4A and 4B illustrate an examples of a bubble shield coupled to a watercraft;

FIG. 5 illustrates another example of an array of watercraft;

FIG. 6 illustrates an example of a watercraft having a light diffuser;

FIG. 7 is a block diagram illustrating features of an image-capture module;

FIG. 8 is an example of a method of capturing images within an image-capture module;

FIG. 9 is an example of a mapping system; and

FIG. 10 is an example of a computer system.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

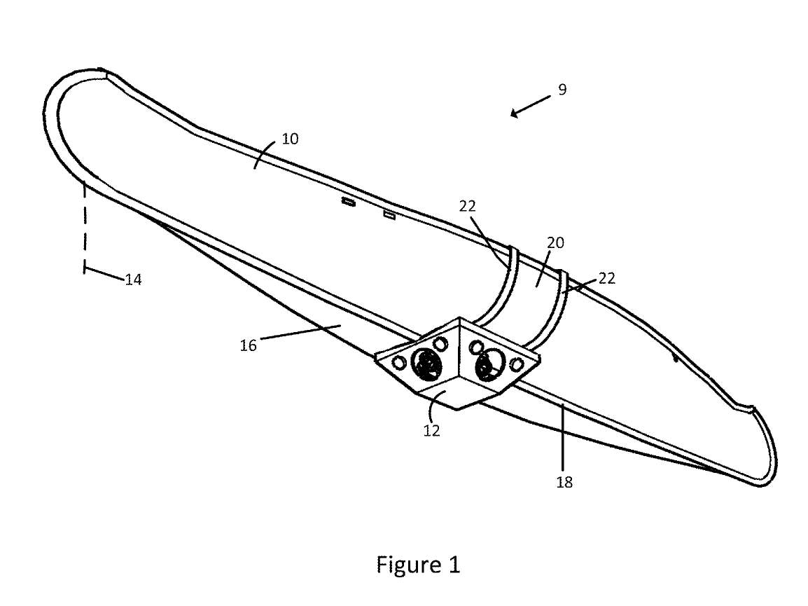

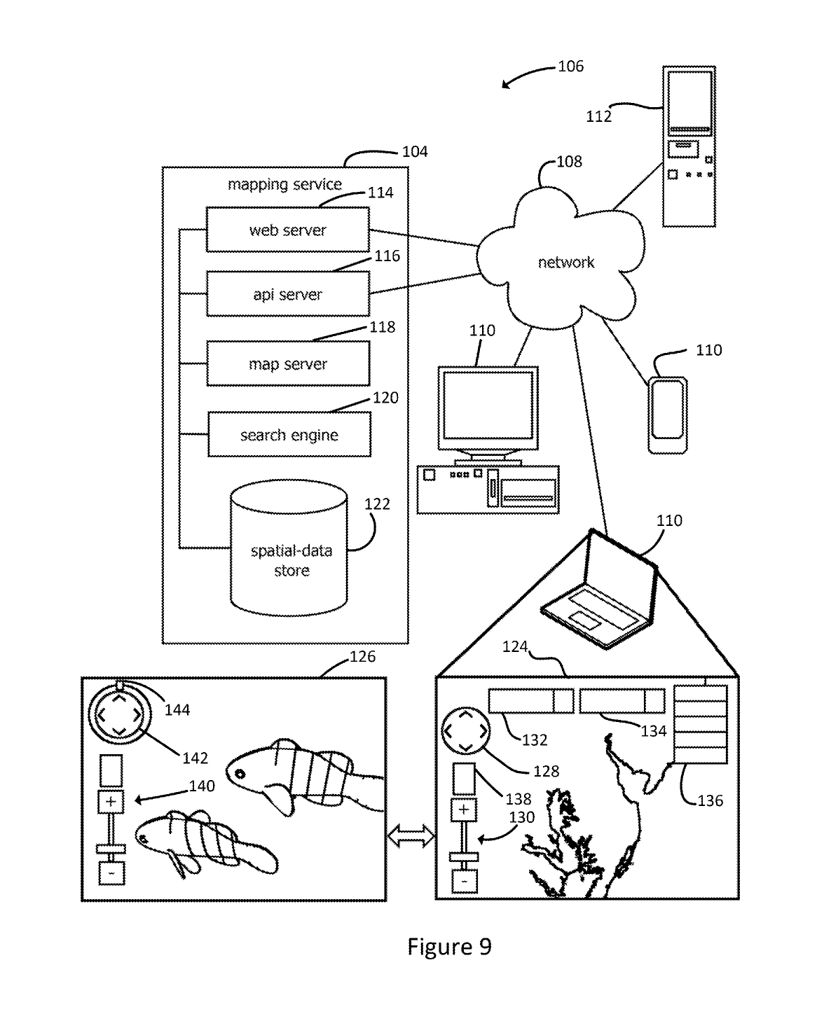

FIG. 1 illustrates an embodiment of a water-borne imaging system 9 having a watercraft 10 coupled to an image-capture module 12. As explained below, the image-capture module 12 may include a plurality of cameras, an orientation sensor, and a location sensor that cooperate to capture a plurality of images in different orientations at different locations along a path and associate with those images data indicative of the orientation and location at which the images were captured. As a result, as explained below with reference to FIG. 9, the images may be presented within a mapping system as an underwater view, and a user interface of the mapping system may receive user commands to navigate along an underwater path, which may cause the mapping system to present the underwater images to the user in a sequence or other arrangement based on the orientation and location data. Further, in some embodiments explained below, the underwater images may be stitched to one another based on the orientation data and the location data such that a user may view a panorama from a given position or a view extending between images captured at different positions.

To facilitate the acquisition of images appropriate for such a mapping system, some embodiments described below may include bubble shields that are expected to reduce the number of bubbles appearing in images and light diffusers expected to improve lighting conditions underwater. Additionally, some embodiments may include an array of watercraft operable to image an underwater area from different positions along a plurality of different paths that are traversed generally concurrently, thereby potentially reducing labor costs.

In this embodiment, the watercraft 10 is a canoe. The illustrated watercraft 10 is operable to carry one, two, or more (or fewer) human beings, and is configured to be propelled by a human being by paddling. Other embodiments may include larger or smaller watercraft, and in some embodiments, the watercraft may be powered, for example with an outboard or an on-board electric or combustion engine or a sail. Some embodiments may include a separate watercraft, e.g., a separate powered watercraft, configured to tow or push the other watercraft described herein. Further, some embodiments may include a watercraft configured to operate below the surface of the water rather than both above and below (spanning) the surface of the water. A human-powered watercraft, such as a canoe, may facilitate efforts to image environmentally or historically sensitive underwater areas in which other propulsion systems are prohibited or are disfavored due to noise or other reasons. Further, a relatively small watercraft, such as a canoe, is expected to disturb the water less, cast a smaller shadow, and be operable to image shallower regions, each of which is expected to improve the number and quality of images captured with the image-capture module 12. Other embodiments, however, may not offer some or all of these benefits, and some embodiments may offer other benefits, as described in greater detail below.

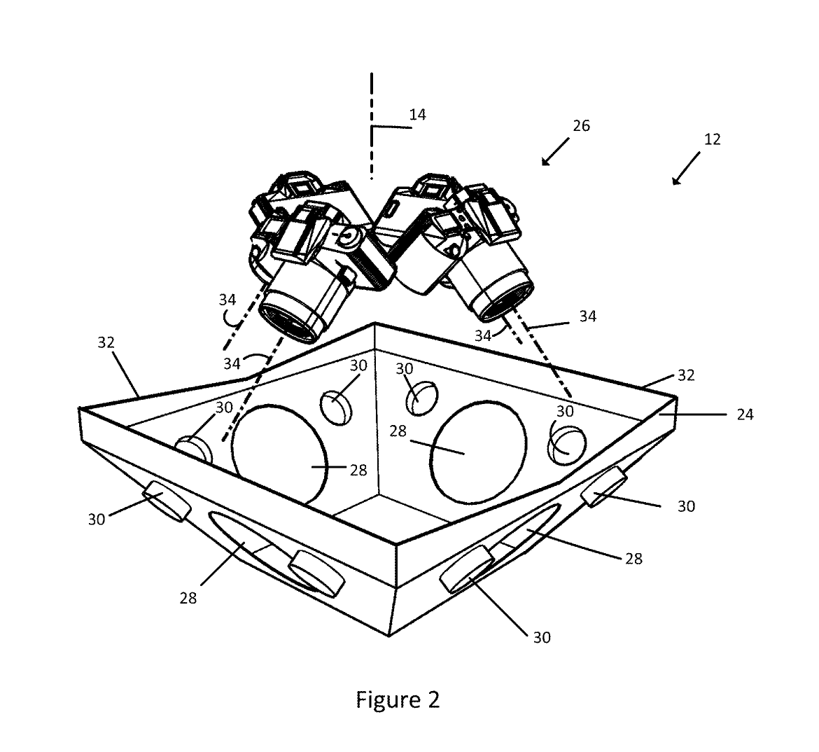

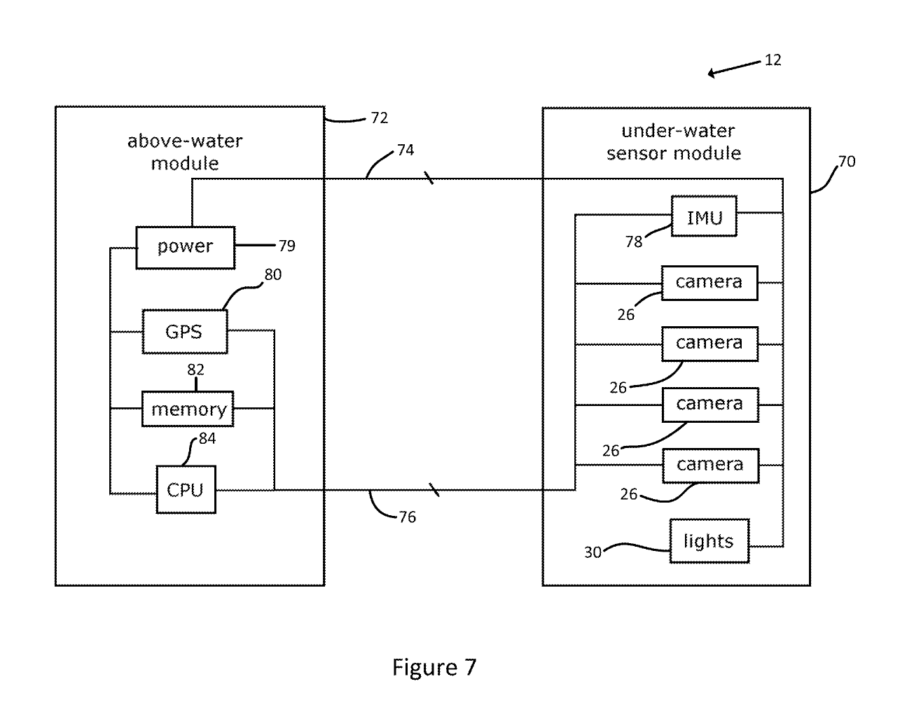

As explained below with reference to FIGS. 2 and 7, the image-capture module 12 may include a plurality of cameras oriented in a plurality of different directions and oriented at an oblique angle relative to each of (or at least one of) the horizon, a waterline of the watercraft 10, or a vertical axis 14 that is perpendicular to the waterline of the watercraft 12 and the horizon. Consequently, in some embodiments, the image-capture module may be operable to capture images in a variety of different directions, for example by capturing images in predetermined directions relative to the watercraft 10 simultaneously while the watercraft 10 is at a given orientation and location. Further, as explained in greater detail below with reference to FIG. 7, the image-capture module 12 may include orientation and geographic location sensors operable to determine (or otherwise obtain data indicative of) the location and orientation of the image-capture module 12, for example as the watercraft 10 moves along a path through the water and as the image-capture module 12 changes orientation due to the watercraft 10 rocking back and forth, for instance when the watercraft 10 encounters disturbances on the water, such as waves.

The image-capture module 12 may be integrally formed with the watercraft 10 or may be formed as a separate component mounted to the watercraft 10. For example, in an integrally formed embodiment, the watercraft 10 may be formed from fiberglass, aluminum, or other materials, and a housing of the image-capture module 12, such as the housing described below with reference to FIG. 2, may be formed as part of a hull 16 (or other structure) of the watercraft 10. In another example, the image-capture module 12 may be a removable component, which may be removably mounted to the watercraft 10, for example mounted straddling a keel 18 of the hull 16. In some embodiments, the image-capture module 12 may be centered over the keel 18, or in other embodiments, the image-capture module 12 may be cantilevered over a side 20 of the watercraft 10, for example secured to an outrigger. In some embodiments, a watercraft may be modified by cutting a hole through the hull 16, and portions or all of the illustrated image-capture module 12 may be placed through the hole to position them below the surface of the water.

The image-capture module 12 may be mounted to the watercraft 10 with a variety of techniques. For example, in some embodiments, the image-capture module 12 may include flanges that are bolted to the watercraft 10 through holes through (or recesses in) the hull 16. In another example, the image-capture module 12 may be secured to the watercraft 10 without disturbing the structure of the watercraft 10, for example by straps 22 extending around the sides 20. The straps 22 may be rigid or flexible material and may envelope the watercraft 10 or may attach to hooks that clasp the sides 20. In some instances of such embodiments, a top surface of the image-capture module 12 may include a resilient material, such as an elastomeric (e.g., rubber) resilient flange, which is expected to prevent the image-capture module 12 from damaging the hull 16 of the watercraft 10 and vice versa. A removable image-capture module 12 is expected to reduce shipping costs for imaging campaigns in which underwater areas are imaged in geographically distributed locations, as different watercraft 10 may be purchased or rented in the different locations, and the image-capture module 12 may be shipped from location to location without incurring the cost of transferring the watercraft 10. In other embodiments, the watercraft 10 may be permanently secured to the image-capture module 12.

FIG. 2 illustrates additional details of the image-capture module 12. In this embodiment, the image-capture module 12 includes a housing 24 and a plurality of cameras 26. The image-capture module 12 may also include other features described below with reference to FIG. 7, such as location sensors and orientation sensors.

The illustrated housing 24 includes a plurality of windows 28 and lights 30. The housing 24 may be generally waterproof or water resistant in some embodiments and may be made of a variety of materials, including composite materials, such as fiberglass, carbon fiber, Kevlar; or metal, such as aluminum or stainless steel; or may be made of plastic, for example vacuum formed or rotocast polypropylene or polyethylene. The illustrated housing 24 does not include a top, but in other embodiments, the housing 24 may include a top, which may seal the interior of the housing 24. In some embodiments, the housing 24 may be made from a generally opaque material and may be generally dark inside, e.g., the joints may be sealed and interior lights omitted or suppressed, such that veiling glare on the windows 28 is mitigated. Further, in some embodiments, a top edge 32 extending around a top perimeter of the housing 24 may include a resilient material, such as a gasket, for example a rubber gasket, which may establish contact with the hull 16 of the watercraft 10.

In this embodiment, the housing 24 includes four, generally radially symmetric faces each having a window 28 and a pair of lights 30. Other embodiments may include other numbers of faces, curved non-planar surfaces, or other shaped housings. Further, other embodiments may include more or fewer of lights 30 or windows 28. Some embodiments may include a single window in the field of view of each of the cameras 26, such as a flat window that is generally parallel to a waterline of the watercraft 10. In some embodiments, substantially all of the housing 24 may be made of a generally transparent material, such as acrylic glass or glass. Further, some embodiments may not include lights 30, which is not to suggest that any other feature described herein may not also be omitted in some embodiments. The windows 28 may be a generally transparent material, such as glass or acrylic glass and may generally align with a field of view of one of the respective cameras 26, for example a field of view of one of the cameras 26 may lie within (e.g., entirely within) the corresponding window 28. In some embodiments, the windows 28 include an anti-reflective coating on a surface of the windows that mitigates veiling glare in the field of view of the cameras 26.

The illustrated cameras 26 are single lens reflex (SLR) cameras. The cameras 26 may, in other embodiments, be other types of still cameras, such as point-and-shoot cameras, web cameras, or other devices having an image sensor. In some embodiments, the cameras 26 may include or may be video cameras. The illustrated cameras 26 are operative to sense light in the visible portion of the electromagnetic spectrum, though in some embodiments, the cameras 26 may additionally or alternatively be operable to sense light in other portions of the electromagnetic spectrum, for example in the infrared portion of the electromagnetic spectrum. Each of the cameras 26 may include an image sensor, such as a charge coupled device (CCD) or a complementary metal oxide semiconductor (CMOS) image sensor. The image sensor may be coupled to a processor and memory within each of the cameras 26, and in some embodiments, the cameras 26 may be coupled to external memory and an external processor, as described in greater detail below with reference to FIG. 7.

The illustrated cameras 26 are generally rotationally symmetrically disposed about the vertical axis 14, and this embodiment, there are four cameras 26, each oriented at an azimuth (e.g., angle in a horizontal plane) that is approximately 90-degrees different from an azimuth each of the adjacent cameras 26. In this embodiment, the illustrated cameras 26 each define an optical axis 34 that is at a negative oblique altitude, or angle with respect to one or more of the following: the horizon, the water line, or a plane normal to the vertical axis 14. In some embodiments, the altitude of the optical axes 34 may be at approximately −45-degrees relative to the one or more of the following: the water line, the horizon, or a plane normal to the vertical axis 14. In some embodiments, the altitude may be at some other angle, for example an altitude less than −15-degrees and greater than −75-degrees, or less than −25-degrees and greater than −65-degrees, for instance. In some embodiments, multiple cameras may be positioned at each azimuth, and each camera at each azimuth may be at a different altitude, for example one camera at a North-facing azimuth may be at an altitude of approximately −15-degrees, one camera may be at an altitude of approximately −45-degrees, and another camera may be at an altitude of approximately −75-degrees, and a set of three such cameras may be positioned that each of four different azimuth or at some other number of azimuths. Further, some embodiments may include a nadir camera having an optical axis that is generally vertical (e.g., perpendicular to the horizon and the waterline of the watercraft 10) and a downward oriented field of view.

In some embodiments, the altitude of each of the cameras 26 may be adjusted based on a depth of features being imaged, for instance the altitude may be decreased (that is, the cameras may be angled further downward) when imaging a relatively deep underwater feature, and the altitude may be increased (that is, that cameras may be angled upward, with the optical axis 34 approaching closer to the horizon) when imaging relatively shallow underwater features. In some embodiments, the image-capture module 12 may include a depth sensor, such as an ultrasound depth sensor, and a servo or other drive may adjust the altitude of the cameras 26 based on (for example exclusively based on or based on additional data) data indicative of the depth sensed by the depth sensor. Each of the cameras 26 may define a field of view, and the optical axes 34 may be generally centered in the field of view. In some embodiments, the number of radially symmetrically disposed cameras may be selected based on the field of view. For example, the number of radially symmetrically disposed cameras may be selected such that the fields of view of each of the cameras 26 overlap to facilitate stitching of images based on features appearing in overlapping portions of the images.

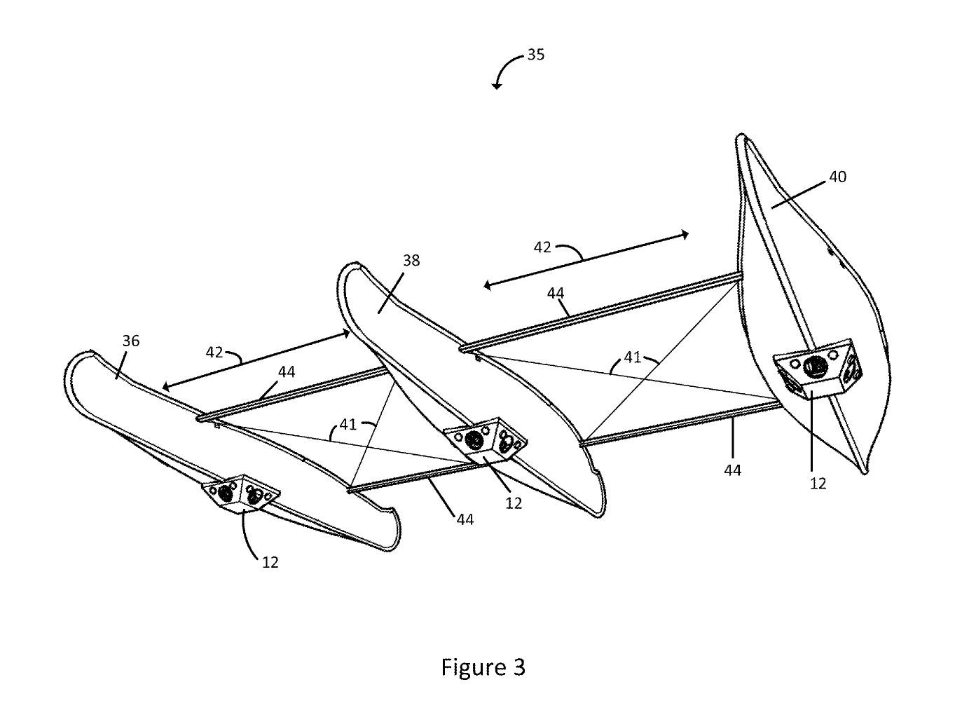

FIG. 3 illustrates an embodiment of an array of water-born image sensors 35 having a plurality of watercraft 36, 38, and 40 each having an image-capture module 12. As explained below, the array 35 may be operable to image an underwater geographic area by capturing images along a plurality of different path traversed by the watercraft 36, 38, and 40 at generally the same time.

The illustrated array 35 includes three watercraft 36, 38, and 40 disposed in spaced relation to one another at distance 42 apart from one another. The distance 42 between each of the watercraft 36, 38, 40 may be approximately equal and, in some embodiments, may be selected based on one or more of the following: a vertical field of view of cameras within the image-capture module 12, an altitude of an optical axis of the cameras, and a depth of features imaged by the image-capture module 12 below the surface of the water. For example, the distance 42 may be selected such that the vertical field of view of the sideways facing cameras overlapped by some desired amount, for example between 5 and 15 percent of the images. Overlapping fields of view are expected to facilitate image-stitching between the overlapping images and determining the positions of the image-capture modules 12 relative to one another based on the overlapping images. In some embodiments, the distances 42 may be adjustable, for example dynamically based on depth measurements (e.g., the distance 42 may be increased in response to an increase in depth and vice versa, for instance by a servo coupled to a rack and pinion and controlled based on a depth measurement), or the distances 42 may be generally fixed. Further, in some embodiments, the distances 42 may be different from one another.

The illustrated embodiment includes three watercraft 36, 38, and 40 positioned generally parallel to one another, but other embodiments may include other arrangements. For example, the watercraft 36, 38, and 40 may be arranged in an approximately V-shaped formation or in an approximately slanted formation with one of the watercraft 36, 38, and 40 leading the other watercraft. In some embodiments, the shape of the array may be selected such that the wake from leading watercraft 36, 38, or 40 interacts with the other watercraft in a favorable manner, for example by diffusing light in an area imaged by one of the other watercraft. Other embodiments may include more or fewer watercraft, for example more than one watercraft, more than two watercraft, more than three watercraft, more than four watercraft, or more than five watercraft.

In this embodiment, each of the watercraft 36, 38, and 40 are generally similar or identical to one another, and each may be an example of the watercraft 10 described above with reference to FIG. 1. In some embodiments, the watercraft 36, 38, and 40 may be different from one another. For example, one or more of the watercraft may be an outrigger, a raft, a flotation device, a human-bearing watercraft, a non-human-bearing watercraft, a submersible, or other cantilevered, floating, or fully immersed structure. In some embodiments, the watercraft 36 and 40 may be omitted, which is not to suggest that any other feature described herein may not also be omitted, and the image-capture modules 12 on either side of the watercraft 38 may be supported by a cantilevered beam extending from either side of the watercraft 38. In the illustrated embodiment, the image-capture modules 12 are each disposed in the approximately the same location and in approximately the same orientation on each of the watercraft 36, 38, and 40, but in other embodiments, the positions and orientations of the image-capture modules 12 may be varied, and some or all of the watercraft 36, 38, and 40 may include additional image-capture modules 12.

In the embodiment of FIG. 3, the watercraft 36, 38, and 40 are held in spaced relation with beams 44. The illustrated beams 44 are generally rigid structures made from any of a variety of materials, such as wooden beams, aluminum beams, or plastic beams secured on each end to one of the watercraft 36, 38, and 40. The beams 44, in some embodiments, may be configured to telescope (e.g., by sliding constituent beams over one another and locking in one of a plurality of selectable positions) to accommodate different distances 42.

In some embodiments, the beams 44 may each be secured to a pair of the watercraft 36, 38, and 40 with a single degree of freedom relative to each watercraft in the pair, for example with a hinge on each end that permits the watercraft 36, 38, and 40 to translate vertically and rotate about a horizontal axis parallel to the beams 44 relative to one another, for example in response to wave propagating past each of the watercraft 36, 38, and 40 at different times. The illustrated embodiment includes cross-cables 41 extending generally diagonally between the ends of the beams 44, and in some embodiments, additional beams, e.g., crossmembers, may extend approximately diagonally between each of the watercraft 36, 38, and 40 to provide additional support to counteract shear stress arising from one watercraft 36, 38, or 40 moving faster than the others. In certain embodiments, the beams 44 may be substantially rigid or flexible beams (for example composite beings formed from material such as fiberglass or carbon fiber or plastic beams) coupled to the watercraft 36, 38, and 40 (e.g., removably coupled or permanently coupled) with zero of freedom at the end of the beams. In embodiments having flexible beams 44, the flex of the beams is expected to accommodate some movement of the watercraft 36, 38, and 40 relative to one another in response to a wave or differences in speed of movement.

In operation, each of the watercraft 36, 38, and 40 may move along three separate paths over a geographic area that is underwater, and the movement may occur generally simultaneously along paths that are generally parallel to one another. The image-capture modules 12 may capture images from different positions along each of these paths, for example at a plurality of positions, in a plurality of different directions, along each of the plurality of paths. Capturing images along a plurality of paths that are traversed generally concurrently is expected to reduce labor costs and speed image acquisition relative to systems that traverse a single path, as a single operator may steer, and in some embodiments propel, all three of the watercraft 36, 38, 40, thereby potentially reducing the number of times a given operator traverses a geographic area while imaging the geographic area from multiple paths.

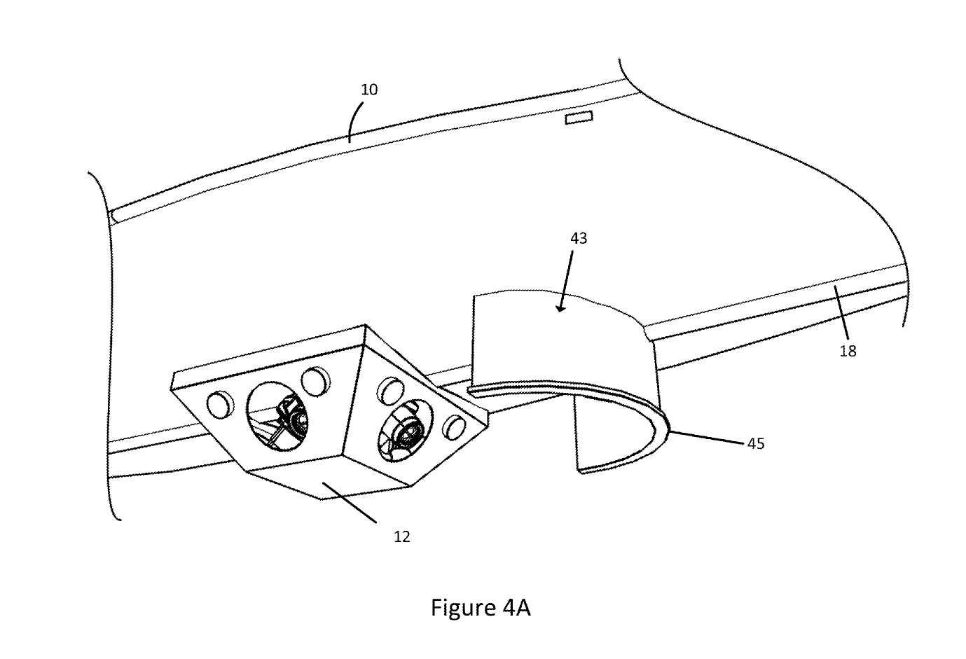

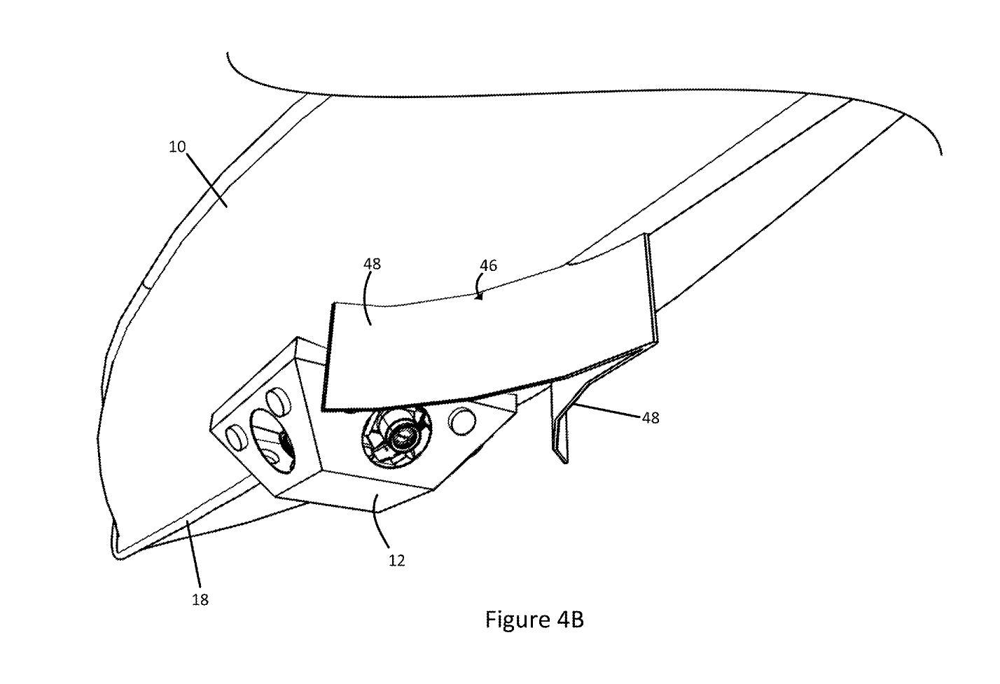

FIG. 4A illustrates an embodiment including the watercraft 10, the image-capture module 12, and a bubble shield 43. In some embodiments, the bubble shield 43 may be coupled to the bottom of the watercraft 10, for example on an upstream side of the watercraft 10 relative to the image-capture module 12 and, as described in greater detail below, may tend to reduce the number of bubbles flowing in front of the cameras of the image-capture module 12, thereby potentially improving image quality.

The bubble shield 43 of the present embodiment is a generally semi-circular in shape and includes a lip 45 at a distal end of the bubble shield 43. The bubble shield 43 may be characterized as having a generally convex upstream surface that is generally reflectively symmetric about the keel 18 of the watercraft 10, and the bubble shield 43 may be generally of uniform thickness or may have some other profile. The lip 45 may extend generally perpendicular to the bubble shield 43 generally in an upstream direction, though other embodiments may include a lip 43 that is differently oriented.

FIG. 4B illustrates another example of a bubble shield 46. In this embodiment, the bubble shield 46 includes two curved plates 48 that are generally reflectively symmetric about the keel 18 of the watercraft 10. A generally reflectively symmetric bubble shield 46 is expected to interfere less with the navigation of the watercraft 10 relative to non-symmetric bubble shields, but other embodiments may include non-symmetric bubble shields.

The illustrated bubble shield 46 generally has a V-shape, but other embodiments may have other shapes, for example a generally convex or C-shape with an apex of the convex shape disposed upstream. In some embodiments, the plates 48 may be generally straight, generally curved, or have some other shape. The illustrated plates 48 are generally curved about a vertical axis, extending generally perpendicular to the waterline of the watercraft 10, but in other embodiments the surface of the bubble shield 46 may be curved about other axes as well, for example about a generally horizontal axis. The illustrated bubble shield 36 is formed from plates 48 generally having a generally uniform thickness, but other embodiments may include a bubble shield 46 having another shape. In some embodiments, the bubble shield may include a single generally horizontal window through which each of the cameras 26 shoot, with the lip 45 positioned to be generally co-planar with the window, and the plates 48 may define the housing in which the cameras 26 (FIG. 2) are disposed.

The bubble shields 43 and 46 may be made from a variety of materials, for example sheet-metal, plastic, or composite materials, such as fiberglass or carbon fiber. In some embodiments, the bubble shields 43 and 46 may be coupled (e.g., bolted, glued, welded, etc.) to the watercraft 10 or to the image-capture module 12, and in some embodiments, the bubble shields 43 and 46 may be integrally formed with the watercraft 10 or the image-capture module 12. The bubble shields 43 and 46 may be positioned such that the bubble shield 46 lies outside a field of view of each of the cameras of the image-capture module 12, in some embodiments.

The illustrated bubble shields 43 and 46 lie entirely or substantially entirely upstream relative to the image-capture module 12, but in other embodiments, some or all of the bubble shields 43 and 46 may be parallel to or downstream of the image-capture module 12. For example, the bubble shield 46 may have a generally teardrop-shape or oval-shape that envelops the image-capture module 12. The bottom edge of the teardrop-shaped shield may be approximately co-planar, e.g., generally flat, and a lip may extend radially outward from the bottom edge. In some embodiments, the bubble shields 43 and 46 may be made from a generally translucent or transparent material, and the material may have a refractive index similar to that of water, thereby potentially rendering portions of the bubble shields 43 and 46 within the field of view of the image-capture module 12 difficult to see within images captured by the image-capture module 12. In some embodiments, the bubble shields 43 and 46 may be made from glass or acrylic glass.

The illustrated embodiment of FIGS. 4A and 4B depict single bubble shields 43 and 46 on a single watercraft 10 having a single image-capture module 12, but other embodiments may include additional bubble shields, additional watercraft 10, or additional image-capture modules 12. For example, the illustrated bubble shields 43 and 46 may be coupled to the other embodiments of watercraft described herein.

In operation, the bubble shields 43 and 46 are expected to divert bubbles away from the field of view of the image-capture module 12. Bubbles in the water are expected to reduce the visibility of underwater features when the bubbles pass within the field of view of the image-capture module 12 (e.g., the aggregate fields of view of the cameras of the image-capture module 12). Diverting the bubbles, or some of the bubbles, is expected to mitigate this effect and improve the visibility of underwater features imaged by the image-capture module 12 relative to systems without a bubble shield. However, the bubble shield 46, like many of the other features described herein, may be omitted in some embodiments.

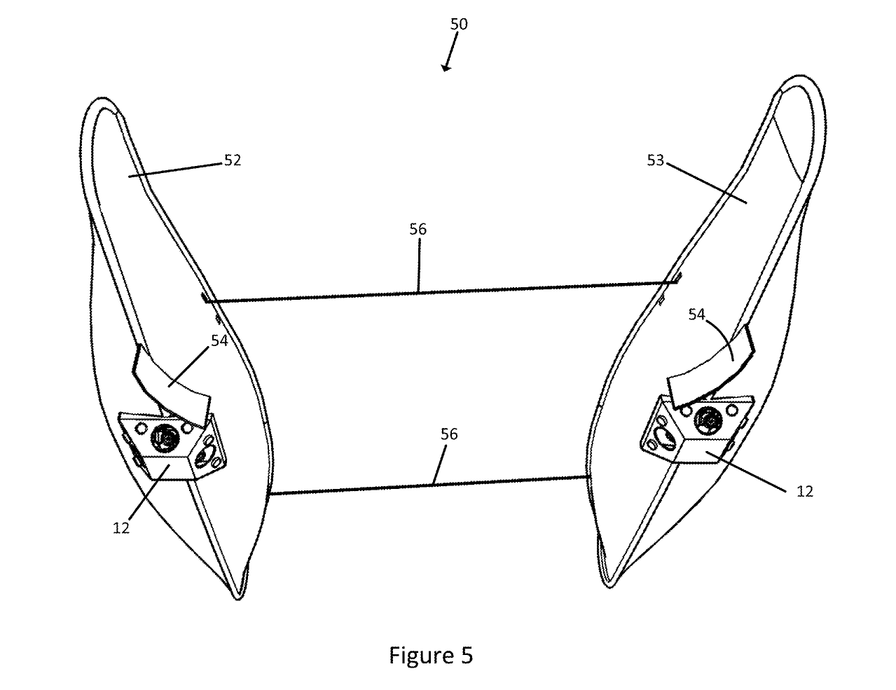

FIG. 5 illustrates another embodiment of an imaging system 50 including a plurality of watercraft 52 and 53 each having an image-capture module 12, a rudder 54, and a connecting cable 56. The illustrated watercraft 52 and 53 may be similar or identical to the other watercraft described herein. As explained in greater detail below, the rudders 54 may tend to push the watercraft 52 and 53 apart while the cable 56 may tend to hold the watercraft 52 and 53 together, placing the cable 56 in tension, thereby holding the watercraft 52 and 54 generally in fixed relation to one another.

The illustrated rudders 54, in some embodiments, may also be bubble shields, such as the bubble shield 46 described above with reference to FIG. 4. The rudders 54 may be constructed from the materials described above with reference to the bubble shield 46 and may be secured (e.g., coupled to the watercraft 52 and 53) in the manner described above with reference to the bubble shield 46. In other embodiments, the rudders 54 may not be bubble shields or may be included along with a separate or integrated bubble shield.

The illustrated rudders 54 are generally sloped or curved plates that tend to push the watercraft 52 and 53 away from one another as the watercraft 52 and 53 move along parallel paths through the water. In other embodiments, the rudders 54 may have another shape, for example a shape without a uniform thickness, a shape that is not curved, or a shape that is not generally continuous, for example an array of smaller plates or baffles. The illustrated embodiment includes one rudder 54 for each watercraft 52 and 53, but other embodiments may include additional rudders. For example, some embodiments may include one rudder disposed upstream of the image-capture module 12 and one rudder disposed generally downstream of the image-capture module 12 on each of the watercraft 52 and 53.

The illustrated cables 56 may be coupled, for example bolted or tied, to each of the watercraft 52 and 53 on facing sides of the watercraft 52 and 53 on each end of the cables 56. The cables 56 may be made from a variety of materials (e.g., materials that support loads in tension but not in compression), for instance steel cabling, rope, chains, or other materials. The illustrated embodiment includes two cables 56, but other embodiments may include additional cables or additional rigid structures extending between the watercraft 52 and 53.

In operation, the watercraft 52 and 53 may move along approximately parallel paths at the same time or approximately the same time while the image-capture modules 12 capture a plurality of images from different positions along each of those paths in the manner described above. As the watercraft 52 and 53 traverse through the water, water flow over the rudders 54 may tend to create a generally horizontal force pushing the watercraft 52 away from the watercraft 53 and pushing the watercraft 53 away from the watercraft 52. At substantially the same time, the cable 56 may be pulled taut as the watercraft 52 and 53 move away from one another, and the cables 56 may be held in tension by the force from the rudders 54 and may prevent further sideways relative movement of the watercraft 52 and 53 away from one another. In this manner, the watercraft 52 and 53 may be held in spaced relation while traversing an area without securing the watercraft 52 and 53 to one another with a rigid structure. The cables 56 are expected to be easier to transport, as cables can typically be coiled and packed in a small area, relative to systems in which the watercraft 52 and 53 are secured to one another with a rigid structure that consumes a relatively large area during transport.

The illustrated embodiment includes two watercraft 52 and 53, but other embodiments may include additional watercraft. For example, a third watercraft may be secured to each of the watercraft 52 and 53 between each of the watercraft 52 and 53. In other embodiments, additional watercraft may be secured between each of the watercraft 52 and 53, for example by cables extending between each of the watercraft, and the watercraft 52 and 53 may pull the cables in tension, thereby potentially holding an array of intermediate watercraft approximately in spaced relation.

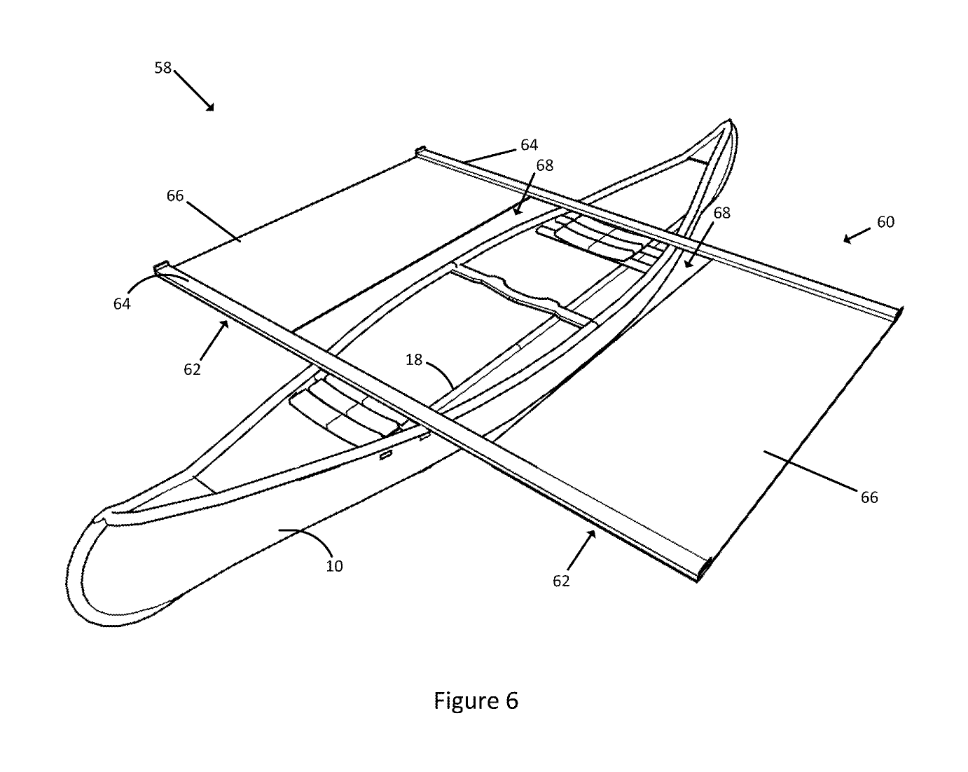

FIG. 6 illustrates an embodiment of a water-born imaging system 58 including a watercraft 10 and a diffuser 60. The diffuser 60, as explained in greater detail below, may diffuse light such that regions underneath (e.g., directly below or below and to the side of) the watercraft 10 being imaged by an image-capture module (not show in this perspective) receives a portion of the ambient light, such as sunlight.

The illustrated diffuser 60 includes a pair of generally symmetric cantilevered diffuser portions 62 extending outward from the sides of the watercraft 10. The illustrated diffuser portions 62 are generally reflectively symmetric about a keel 18 of the watercraft 10, but in other embodiments, the portions 62 may not be symmetric, or one or both portion may be omitted, which is not to suggest that any other feature described herein may not also be omitted.

The diffuser 60, in this embodiment, includes beams 64 and a pair of diffuser surfaces 66 disposed on either side of the watercraft 10 over the water when the watercraft 10 is in the water. The beams 64 may be made of a generally rigid or flexible material, for example aluminum beams, fiberglass beams, or plastic beams, or wooden beams (or combinations thereof), and the diffuser plates 66 may be made of a transparent or generally translucent material, such as glass or plastic, such as acrylic glass. The diffuser surfaces 66, in some embodiments, may be a structure configured to diffuse light passing through the diffuser surfaces 66, such as frosted glass, a lenticular array, a plenoptic lens, or a substantially transparent material having an irregularly-shaped surface.

In some embodiments, the diffuser surfaces 66 may be a generally rigid material, such as glass, or the surfaces 66 may be a generally flexible material, such as a sheet of plastic, e.g., bubble wrap, extending between the beams 64. In some embodiments, the diffusing surfaces 66 may include apertures or channels for the removal of water that splashes onto the surfaces 66 and to reduce forces from wind blowing against the surfaces 66. In some embodiments, the diffusing surfaces 66 may be slanted downward, for example toward or away from the watercraft 10 to further channel water off of the surfaces 66. Or in some embodiments, the surfaces 66 may be generally horizontal and generally coplanar. In the illustrated embodiment, the surfaces 66 are spaced away from the watercraft 10, such that a gap 68 exists on either side. In some embodiments, the gap 68 may be sized such that a canoe paddle fits within the gap 68.

The beams 64 may be coupled to the watercraft 10 with a variety of techniques. For example, the beams 64 may be bolted, clamped, strapped, or otherwise attached, removably or permanently to the watercraft 10. The diffusing surfaces 66 may be coupled to the beams 64 with a variety of teaching techniques, as well, for example, bolting, gluing, riveting, or otherwise attaching (removably or permanently) the end of the diffusing surfaces 66 to the beams 64. In some embodiments, the beams 64 and the diffusing surface 66 may be integrally formed, for example from a single material, such as acrylic glass having a curved or bent perimeter to provide support. In some embodiments, the water craft 10 may include a mast, and a distal portion of the beams may be connected to the mast by a cable to provide additional support.

In some embodiments, the diffusing surfaces 66 may be disposed between beams or cables extending between watercraft, such as the cables 56 of FIG. 5 or the beams 44 of FIG. 3. The illustrated embodiment includes a single diffusing surface 66 on either side of the watercraft 10, but other embodiments may include a diffusing surface 66 on only one side of the watercraft 10 or multiple surfaces on either side of the watercraft 10, for example a diffusing surface disposed toward the bow and a diffusing surface disposed towards the aft of the watercraft 10.

In operation, the diffusing surfaces 66 may diffuse light such that the light reaches areas imaged by the image-capture module attached to the watercraft 10. In some embodiments and some use cases, the watercraft 10 may cast a shadow over regions being imaged by an image-capture module. Similarly, some regions of an underwater area being imaged may include structures that cast their own shadows. The underwater regions falling within the shadows may be difficult to image, as the regions within the shadow may have insufficient light to be sensed accurately by the image-capture module. The diffuser 60 may diffuse sunlight such that a portion of the sunlight is redirected into regions that would otherwise fall within a shadow, thereby potentially illuminating regions that would otherwise be difficult to image.

Additionally, or alternatively, other techniques, such as other types of diffusers, may be used to redirect sunlight. For example, the surface of water on either side of the watercraft 10 may be disturbed, for instance with a comb-like structure extending from the sides of the watercraft 10 into the water, with bubbles injected into the water on either side of the watercraft 10, or with water sprayed over the sides of the watercraft 10. These other types of diffusers may be configured to disturb the surface of the water, which may also redirect sunlight into areas that would otherwise be difficult to image.

FIG. 7 illustrates additional details of the above-described image-capture modules 12. In this embodiment, the image-capture module 12 includes an underwater module 70 and an above-water module 72. In some embodiments, a portion or substantially all of the under-water sensor module 70 may be immersed in water, and a portion or substantially all of the above-water module 72 may be disposed above the water, for example within a hull of one of the above-described watercraft. The above-water module 72 may be coupled to the under-water sensor module 70 by a power connection 74 and a data connection 76. In some embodiments, the power connection 74 may conduct electrical power from the above-water module 72 to components of the under-water sensor module 70, and the data connection 76 may convey data and commands between the above-water module 72 and the under-water sensor module 70.

In some embodiments, the under-water sensor module 70 may be operable to obtain images of underwater features and approximately concurrently sense the orientation of the under-water sensor module while obtaining the images, and the above-water module 72 may be operable to control the under-water sensor module 70, provide power to the under-water sensor module 70, and receive positioning signals for determining the geographic location of the image-capture module 12, as described in greater detail below. In some embodiments, the under-water sensor module 70 may include the features described above with reference to FIG. 2.

The under-water sensor module 70 of the present embodiment includes an inertial measurement unit (IMU) 78 and the above-described cameras 26 and lights 30. The under-water sensor module 70 may be partially or entirely disposed within the above-described housing 24 (FIG. 2). The inertial measurement unit 78 may be secured to the cameras 26, for example with zero degrees of freedom, either removably or irremovably, such that the inertial measurement unit 78 translates and is reoriented as the cameras 26 translate and are reoriented, for instance when a wave passes under a watercraft coupled to the image-capture module 12. In some embodiments, the inertial measurement unit 78 may include a gyroscope or an accelerometer (e.g., a combination of a gyroscope and an accelerometer), such as a three axis gyroscope or accelerometer configured to sense rotation and acceleration along and about three, generally orthogonal axes. In some embodiments, the inertial measurement unit 78 may include a sensor configured to detect changes in velocity or changes in rotational velocity of the cameras 26 and an integrator configured to integrate signals from the sensor such that a net movement may be calculated, for instance by a processor of the inertial measurement unit 78, based on an integrated movement about or along each of a plurality of axes. In some embodiments, the inertial measurement unit 78 may be configured to receive location signals or error signals from the above-water module 70, e.g., from a global positioning system module described below or a compass, and suppress accumulated error based on the received signals, e.g., based on a difference between an expected change in position based on the inertial measurement unit 78 and an actual change in position or orientation received from the above-water module 72.

The illustrated inertial measurement unit 78 is disposed in the under-water sensor module 72, thereby positioning the inertial measurement unit 78 relatively near the cameras 26 (e.g. in this context, within approximately 30 cm, 10 cm, or 5 cm) such that movement of the inertial measurement unit 78 relatively closely corresponds to that of the cameras 26, but in some embodiments, the inertial measurement unit 78 or another inertial measurement unit 78 may be disposed in the above-water module 72. Or in some embodiments, the inertial measurement unit 78, like other features described herein, may be omitted. The inertial measurement unit 78 may receive power from the above-water module 72 and output an orientation signal or a position signal indicative of the orientation or position, respectively, of the under-water sensor module 70 and the cameras 26.

In some embodiments, the inertial measurement unit 78 may output such a signal in response to a command from the above-water module 72 to the cameras 26 to capture an image (e.g., solely in response to this signal or in response to this signal and other conditions obtaining), in response to some duration of time elapsing that corresponds to a time between activation of the cameras 26 to capture an image (e.g., periodically), or in response to a signal from the cameras 26 indicating that an image is going to be, recently was, or is being captured. In some embodiments, a measurement may be performed by the inertial measurement unit 78 in response to an image being captured or requested. In other embodiments, the inertial measurement unit 78 may output a signal with a timestamp by which measurements may be selected and correlated with images from the cameras 26, images which may also be associated with a timestamp indicating the time at which an image was captured such that images and measurements may be associated based on differences between the timestamps, e.g., with the closest timestamp.

Alternatively, or additionally, some embodiments may include other orientation sensors. For example, some embodiments may include a magnetometer configured to sense the azimuth of the cameras relative to magnetic North. Some embodiments may include a light detecting and ranging (LIDAR) sensor configured to sense data indicate of the altitude of the cameras relative to the surface of the water. Some embodiments may include a sonar sensor operable to sense the ground under a watercraft and provide data indicative of the altitude and azimuth of the cameras. In some embodiments, signals from the above-mentioned sensors may be combined, e.g., with sensor fusion techniques, such that a more accurate aggregate orientation measurement is obtained relative to the measurements provided by the individual sensors.

The illustrated cameras 26 may receive power from the above-water module 72 via the power connection 74, and the cameras 26 of this embodiment, may exchange commands and data with the above-water module 72 via the data connection 76. In some embodiments, images captured by the cameras 26 may be stored in memory on the cameras 26, or images captured by the cameras 26 may be transmitted to the above-water module via the connection 76. In some embodiments, the under-water sensor module 20 may have its own power source and may not be communicatively coupled to the above-water module 72 during image capture, e.g., images may be associated with measurements above water based on timestamps after the data is acquired.

In this embodiment, the lights 30 may receive power from the above-water module 72 via the power connection 74. In some embodiments, power to the lights 30 may be interrupted (e.g., by the power source in response to a command from the below-described central processing unit) when (e.g., in response to) the cameras 26 are not capturing an image and may be restored when the cameras 26 are capturing an image to conserve power. In some embodiments, the lights 30 may be selectively turned on by the power source based on an amount of light available to the cameras 26, for example based on signals from a light sensor on the cameras 26 indicative of an amount of light from a feature being imaged within a field of view of the cameras 26.

In this embodiment, the above-water module 72 is separate from the under-water sensor module 70 and is at least partially above water in order to facilitate reception of signals indicative of the geographic location of the image-capture module 12, such as global positioning system (GPS) signals from satellites. In other embodiments, the above-water module 72 may be integrated with the under-water sensor module 70 and, for example, an antenna may extend above the surface of the water. Or in some embodiments, signal indicative of geographic location are not received by the image-capture module 12.

In this embodiment, the above-water module 72 includes a power source 79, a GPS module 80, memory 82, and a CPU (or other processor) 84. The above-water module 72 of this embodiment may be disposed within a water resistant or waterproof housing, such as a plastic housing disposed within one of the above-described watercraft. In some embodiments, a cable or cables may extend over (or through) a side of the watercraft to the under-water sensor module and contain the power connection 74 and the data connection 76.

The power source 79 in this embodiment may include a variety of different sources of power. For example, the power source 79 may include a battery, a generator, a fuel cell, a solar cell, a generator powered by a wind turbine, a manually powered generator, or other sources electrical power. In some embodiments, the power source 79 may be disposed in the under-water sensor module 70 in order to lower the center of gravity of the image-capture module 12 and potentially render the watercraft more stable.

The illustrated GPS module 80, in this embodiment, is an example of a location module. The GPS module 80 may be operable to receive signals from global positioning system satellites and determine a position, for example a relative geographic location or an absolute geographic location in latitude and longitude, of the image-capture module 12. Alternatively or additionally, other embodiments may include a location module operable to determine location based on other signals, for example signals from a beacon at a selected origin or signals from the current wireless environment, for example signals from cellular towers by which position may be determined. Placing the GPS module 80, or an antenna of the GPS module 80, above the surface of the water is expected to improve the accuracy of the GPS module 80, as signals from global positioning system satellites or other location signals are expected to be attenuated or substantially eliminated underwater.

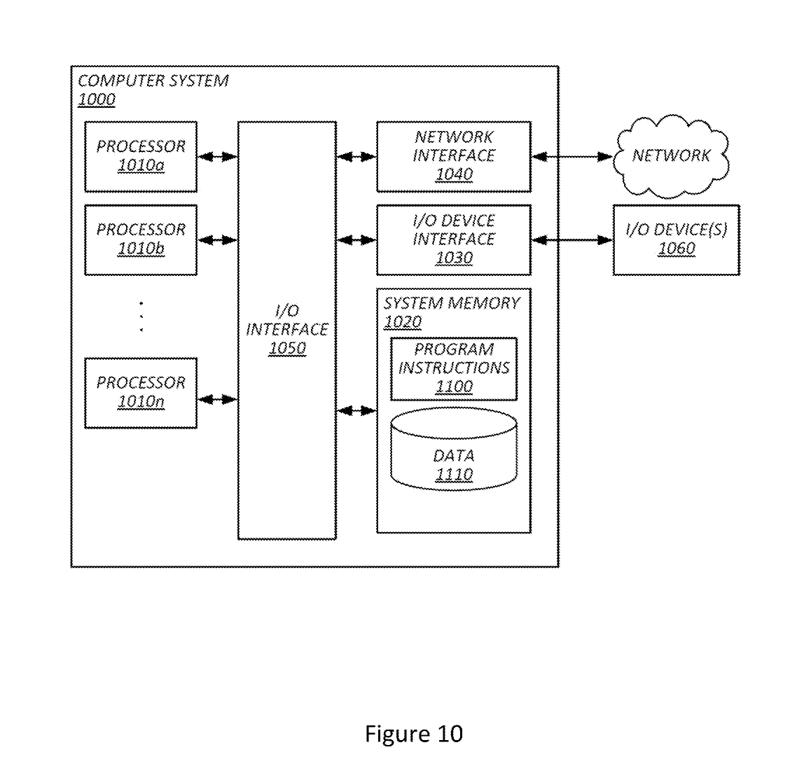

In this embodiment, the memory 82 may include any of a variety of different types of memory, and in some embodiments, the memory 82 and the CPU 84 may be part of a computing device, such as one of the examples of computing devices described below with reference to FIG. 10. In this embodiment, the memory 82 is shown as being a single functional block within the above-water module 82, but another embodiments, the memory 82 may be embodied by multiple memory devices disposed within the above-water module 72 or within the under-water sensor module 70 (e.g., in both), including memory within the cameras 26.

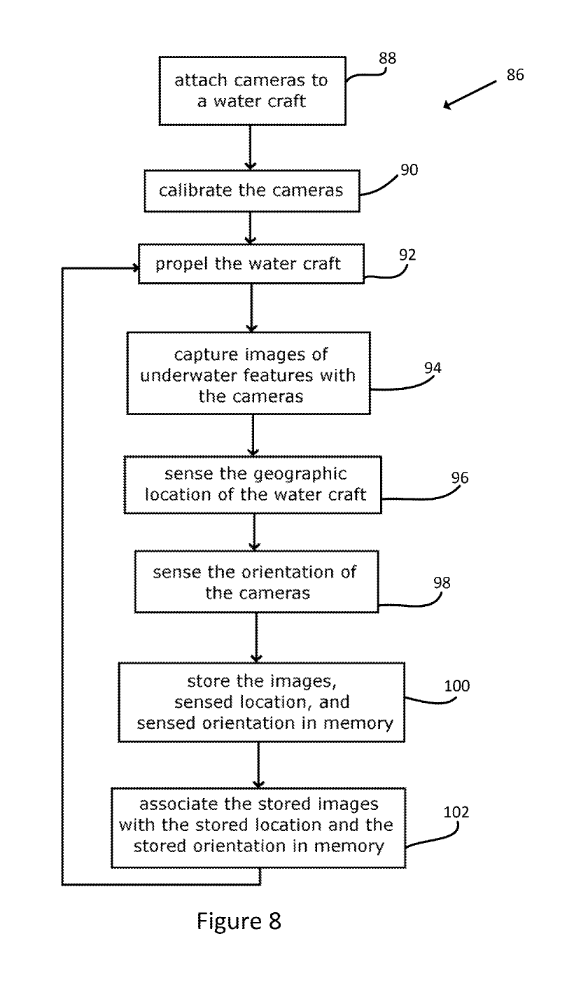

The illustrated CPU 84 is an example of a processor that may be included within the above-water module 72. The CPU 84 may output commands to the GPS module 80, the power source 79, the memory 82, and the components of the under-water sensor module 70 to effectuate some or all of the functionality described herein. In other embodiments, the functionality described herein may be loosely coordinated by the CPU 84, and some or all of the functionality may be performed by processors within the other components of the image-sensor module 12. In some embodiments, the CPU 84 or other processor may execute instructions stored by the memory 82, which may be a tangible non-transitory machine readable memory, and executing those instructions may cause the image-capture module 12 to perform the functionality described herein, e.g., data-acquisition and calibration portions of the process described below with reference to FIG. 8.

In operation, the image-capture module 12 may be carried along a path on or near (e.g., within 2 meters of, within 1 meter of, or within 50 cm of) the surface of the water by one of the above-described watercraft, and the image-capture module 12 may capture images at a plurality of different locations along that path in a plurality of different directions at each location, along with orientation data indicative of the orientation of the cameras 26 when the images are captured and position data indicative of the position of the image-capture module 12 when the images are captured. For example, the CPU 84 may output a command instructing the cameras 26 to capture an image, a command instructing the inertial measurement unit 78 to measure an orientation, and a command instructing the GPS module 80 to determine a position. In response, the devices 26, 78, and 80 receiving these commands may perform the requested task and transmit the obtained data to the memory 82, which may associate the obtained data with one another. With the associated data, an interactive underwater navigable view of a geographic area, for example from the perspective of a snorkeler, may be formed and presented to users in an interface on a user device, as described in detail below with reference to FIG. 9.

As noted above, some embodiments may include multiple image-capture modules. In some embodiments, some of the features of the image-capture module 12 may only be present in some of the plurality of image-capture modules, which is not to suggest that any feature described herein may not also be omitted in some embodiments. For example, some embodiments may include a plurality of image-capture modules mounted on a single watercraft, for instance at different positions along the keel of the watercraft, at different positions perpendicular to the keel, or (i.e., and/or) at different depths, or some embodiments may include multiple watercraft, each having one or more image-capture modules, as described above. In some embodiments, one of the plurality of image-capture modules may include the above-water module 72, and the single above-water module 72 may be coupled to a plurality of under-water sensor modules 70 distributed in one of the fashions described above. Sharing an above-water module 72 is expected to reduce the cost of the image-capture module 12, though other embodiments may include one above-water module 72 for every under-water sensor module 70, e.g., for purposes of standardizing the image-capture modules 12 and simplifying training, operation, configuration, and repairs.

FIG. 8 illustrates an example of a method 86 of capturing underwater images with an image-capture module moving along a path through the water. The illustrated method 86, in some embodiments, may be performed by the above-described image-capture modules 12. In some embodiments, instructions for performing portions of the method 86 may be stored in the memory 82 (FIG. 7) and may be executed by the CPU 84 described above. The method 86 may yield data for forming an interactive underwater view from the perspective of a snorkeler of underwater features, and users may view this data to tour underwater areas as described below with reference to FIG. 9. In some embodiments, the obtained data may be used for other purposes, for example for surveying underwater features (e.g., counting a species of fish or other wildlife or searching for candidate items for salvage), generating three-dimensional maps of underwater structures based on stereoscopic views of those structures (e.g., based on images from different paths of the same feature), or capturing images that are presented or analyzed in some other fashion.

In this embodiment, the method begins with attaching cameras to a watercraft, as illustrative of block 88. Attaching cameras to watercraft may include attaching one of the above-described image-capture modules 12 to one of the above-described watercraft 10.

Next, in this embodiment, the cameras may be calibrated, as illustrated by block 90. Calibrating the cameras may include navigating the watercraft over a reference structure, for example an image disposed on a heavier-than water plate that depicts a reference pattern, which may include regions of a know color for calculating white balance and regions of a known spatial distribution for spatially calibrating the cameras, e.g., to characterize distortion from a lens of the cameras such that the distortion can be reversed with a transformation based on the spatial calibration data. In some embodiments, the reference structure may include an underwater grid, for example a grid formed by a net stretched over an underwater area, and the cameras may be calibrated based on images captured of the net, for example by determining a spatial distortion of the image-capture modules by comparing images of the grid to a known shape of the grid and mapping distorted pixels to a rectilinear representation of the image. Thus, in some embodiments, images captured by the image-capture module may be transformed by reversing distortions measured with step 90 based on the calibration data.

Next, in this embodiment, the watercraft may be propelled through the water, as illustrated by block 92. Propelling the watercraft may include manually propelling the watercraft with a paddle or by pushing the watercraft while standing on the sea floor, or in some embodiments, the watercraft may be propelled with an onboard propulsion system, such as an outboard electric or gasoline motor, or with a sail, for example. Propelling the watercraft may also include towing one or more watercraft with one or more powered watercraft.

Next, in this embodiment, images of underwater features may be captured with the cameras, as illustrated by block 94. Capturing images of underwater features with the cameras may include diffusing light, such as sunlight such that the underwater features are illuminated by the diffused light, as described above with reference to FIG. 6. Capturing images of underwater features may also include capturing a plurality of images from a given position in a plurality of different directions, as described above with reference to FIG. 2.

The present embodiment of method 86 may also include sensing the geographic location of the watercraft, as illustrated by block 96. Sensing the geographic location may include sensing the latitude and longitude of the watercraft, as described above with reference to the GPS module 80 of FIG. 7. In some embodiments, geographic location may be sensed at approximately the same time as images are captured in the step labeled with block 94, or the geographic location may be sensed at some other time and correlated with the images, for example the location sensed closest to the time in which the images are captured may be the sensed location of the step labeled with block 96.

The method 86, in this embodiment, may further include sensing the orientation of the cameras, as illustrated by block 98. Sensing the orientation of the cameras may include sensing the orientation with the above-described inertial measurement unit 78 of FIG. 7. As with sensing location, orientation may be sensed at approximately the same time as the images are captured, or orientation may be sensed at a different time, for example shortly after or shortly before the images are captured, for instance before the cameras move substantially.

Next, in this process 86, the images, sensed location, and sensed orientation may be stored in memory, as illustrated by block 100. Storing this data may include storing the data in the above-describe memory 82 of FIG. 7. The images, sensed location, and sensed orientation may also be associated with one another in memory, as illustrated by block 102. This data may be associated based on similar time stamps or based on the manner in which the data is stored. For instance, the sensed location and sensed orientation may be stored as meta-data of image files. In some embodiments, this data may be associated in a database, e.g., as entries of a relational database in the same entry or linked to one another through key values of separate tables. The data may be associated in some embodiments by storing the sensed data as attributes of an instance of the same object, e.g., an list of image objects, or in some embodiments, the data may be associated by storing the data as related entries in a document, e.g., as sibling (or otherwise related) fields in a hierarchical document, such as an extensible markup language (XML) document or a JavaScript object notation (JSON) document.

The images may be processed based on the associated sensed orientation data and position data to populate a data store for displaying images of the imaged area, e.g., in the form of an interactive, navigable view described below with reference to FIG. 9. For instance, the images may be stitched together based on the position and orientation data. The orientation data may indicate a change in orientation between consecutive images, and the images may be aligned with one another for stitching based on the indicated change in orientation such artifacts from the stitching process (e.g., discontinuities in the image) are reduced relative to systems in which stitching occurs without orientation data. The resulting stitched images may be indexed or otherwise addressed according to the position data such that a user may select images based on position and view a sequence of positions along a path, also as described below. Thus, in some embodiments, the above-described process may obtain relatively high-quality, well lit images and data for forming such interfaces at a relative low cost and relatively quickly, though not all embodiments necessarily provide all of these benefits.

In some embodiments, the images acquired with the above-described techniques may be texture mapped onto a surface by performing a bundle adjustment based on the orientation data and stitching the images together such that the images may be the texture mapped onto a surface. For instance, a pose, or 3-dimensional orientation and location of the camera indicating azimuth and altitude of the optical axis of each camera and position in space of each camera, may be calculated based on the orientation data and location data. In some embodiments, the pose may be calculated based on a combination of a number of signals indicative of orientation, e.g., by fusing signals from a number of orientation sensors. Based on the calculated pose, the images may be texture mapped onto a surface representative of the imaged geographic area, e.g., a flat plane or a 3-dimensional, e.g., faceted, surface, by perspective transforming the images based on the calculated pose relative to the surface to which the image is mapped. Images depicting the imaged underwater area may be formed by rendering views of the texture mapped surface from viewer-selected positions such that a viewer may navigate to different perspectives of the imaged area. Some embodiments may also stitch images captured in the same direction from different positions into mosaic oblique views that are viewable by scrolling side-to-side along a traversed path.

The images captured with the above-described systems and methods may be accessed and viewed by users of a geographic information service (GIS) or a mapping service, an example of which is the mapping service 104 illustrated in FIG. 9. The illustrated mapping service 104 is part of a computing system 106 including the mapping service 104, a network 108, user devices 110, and a Web server 112. As explained below, the mapping service 104 may display interactive maps to users, who may interact with the maps to select and view panoramas, such as the panoramas formed in accordance with the techniques described above and provided by a panorama-providing service of the mapping service 104. Or in some embodiments, the mapping service 104 may be a panorama-providing service without the capacity to provide maps, which is not to suggest that any other feature described herein may not also be omitted.

In some embodiments, the illustrated computing system 106 may be a geographically distributed computing system. For example, mapping service 104 may be remote from client devices 110, both of which may be remote from Web server 112. In other embodiments, one or more of these components 104, 112, and 110 may be located in the same place (e.g., a shared local-area network or physical building) or integrated into a single computing device. In some embodiments, each of the components 104, 112, and 110 of the computing system 106 may include one or more computing devices, such as one or more of the examples of computing devices described below with reference to FIG. 10, and the components 104, 112, and 110 may serve different roles in different embodiments and different use cases: for example the mapping service 104 may operate as a server and the devices 112 and 110 may operate as clients of the server 104, or in some use cases or embodiments, the components 104, 110, and 112 may operate as peers in a peer-to-peer architecture.

In this embodiment, the components of the computing system 106 are connected by network 108, which in some embodiments may include the Internet. The network 108 may also include intermediary networks, such as local-area networks, wireless-area networks, cellular networks, and the like. Further, in some embodiments, communication over the network 108 may include communication via intermediary devices, such as servers that cache content, such as webpages depicting maps or portions of panoramas, for expedited delivery to user devices 110, and intermediary devices that pre-render portions of content for user devices 110, e.g., by re-sizing images based on a display on user devices 110 or constructing portions of a document-object model, a style tree, a rule tree, a context tree, or a render tree based on the communicated content for the user device 110.

In this embodiment, the mapping service 104 includes a Web server 114, an application program interface (API) server 116, a map server 118, a search engine 120, and a spatial-data store 122.

The mapping service 104 may be a computing system, such as a computing system having one or more computing devices connected to one another over a network. The illustrated functional blocks 114, 116, 118, 120, and 122 may be embodied in whole or in part at hardware, for example as a field programmable gate array or an application-specific integrated circuit, or in whole or in part as software executing one or more processes that provide some or all of the functionality described herein, and such software may be stored on a non-transitory tangible-machine readable medium, examples of which are described below with reference to FIG. 10. In this embodiment, the functional blocks 114, 116, 118, 120, and 122 are described as discrete and separate functional blocks, but in some embodiments, structures or code by which these blocks are implemented may be intermingled or otherwise organized in different groupings than those illustrated.

In some embodiments, the Web server 114 may be operable to receive requests for webpages, transmit requests for content to construct the requested pages, received the requested content, and transmit the webpages including requested content to the requesting device via the network 108. For example, the Web server 114 may listen to a Transmission Control Protocol/Internet Protocol (TCP/IP) port connected to the network 108 at an Internet Protocol (IP) address of the network 108 and detect a request for a webpage, such as a webpage depicting a map. The Web server 114 may also be operative to maintain a plurality of sessions, such as one session with each of the user devices 110 occurring over overlapping periods of time, in which a user interacts with a requested interactive map webpage on one of the user devices 110. For instance, the Web server 114 may store state data indicative of the state of a session or receive such state data from the user devices 110 and receive data indicative of user interactions with an interactive map and change the state data in response to the user interactions. In some embodiments, the Web server 114 may transmit a request for map data to the map server 118 or the spatial-data store 122 in response to a request for a webpage or in response to receipt of data indicative of user interactions with the webpage, e.g., user commands requesting a different view. Further, in some embodiments, the Web server 114 may receive user search queries and transmit those search queries to search engine 120 to request searches based on the queries. The Web server 114 may receive content responsive to these requests, encode the received content in a webpage or content for a webpage, and transmit the encoded data to the user devices 110 or the Web server 112.

In some embodiments, the API server 116 may also receive requests for content and, in response, request other components of the mapping service 104 to obtain the requested content, which the API server 116 may transmit to a requesting user device 110 or the Web server 112. In some embodiments, the API server 116 may be operable to provide content upon which other webpages are based, such as webpages served by the Web server 112, or provide content upon which a display is based in a special-purpose application, such as a mapping application, a navigation application, a social networking application, or other application, which may operate outside of a web browser.

The illustrated map server 118 may be operable to receive requests for map data from the Web server 114 or the API server 116 and, in response, obtain the map data from the spatial-data store 122 and transmit the obtain map data to the requesting Web server 114 or the API server 116. Examples of such map data are described below with reference to a user interface operating on the user devices 110.

Similarly, the search engine 120 may be operable to receive search queries from the Web server 114 or the API server 116, identify content responsive to the query, and transmit the identified content (which may also include transmitting a pointer to the content, such as a uniform resource identifier (URI)) to the requesting Web server 114 or API server 116.

The spatial-data store 122 may store a variety of different types of data relating to geographically distributed objects, such as roads, buildings, rivers, lakes, mountains, political boundaries, and the like. For example, the spatial-data store may include images of geographically distributed objects, and images may be associated with metadata indicating the geographic area to which the image pertains such that images of adjacent geographic areas can be displayed adjacent one another to depict a larger geographic area than that depicted by either one of the images being combined. In some embodiments, the stored images may depict the same geographic area at different resolutions or granularity, which may also be reflected by the metadata such that a resolution can be selected. The spatial-data store may also include data describing attributes of geographically distributed objects. For example, the data describing such attributes may include traffic data describing the conditions of roads; weather data describing the weather, weather forecast, or past weather in geographic areas; social networking data describing the location of members of adjacent nodes of a social graph and their relationship or other attributes; business listings describing attributes of geographically distributed businesses; and the like. The spatial-data store 122 may be operable to receive requests for data stored within the spatial-data store 122 from the other components of the mapping service 104 and transmit the requested data to the requesting component.

In some embodiments, the spatial-data store 122 may store images depicting different views of geographic areas. For example, the spatial-data store may include images depicting a satellite-view of the geographic area, a birds-eye level view of a geographic area (for example images acquired from an airplane), an eye-level view of geographic areas (for example images acquired from a camera mounted to a structure on the ground, such as a ground-based vehicle, a person, or a tripod), and a snorkeler-view based on images acquired with the above-described techniques. In some embodiments, one or more of these views may include images stitched to one another with the above-described techniques.

In some embodiments, the illustrated Web server 112 may be operable to serve webpages to the user devices 110, and the webpages may include content from the mapping service 104. In some embodiments, the Web server 112 may receive a request for a webpage or other content from a user device 110 and, in response, may construct the requested webpage by requesting content for the webpage from the mapping service 104 via either the Web server 114 or the API server 116. In some embodiments, the Web server 112 may be operable to serve a webpage to the user devices 110 that includes a request for content from the mapping service 104, and the user device 110 may request this content from the mapping service 104.

The illustrated user devices 110 may be a non-portable device, such as a desktop computer, a gaming console, or a set-top box, or a portable device, such as a laptop, a tablet computer, or a smart phone, each of which may include a power source (e.g., a battery or fuel cell) for off-grid operation. In this embodiment, each of the user devices 110 are connected to the network 108 and include a display, a processor, and memory. In some embodiments, the user devices 110 may be one of the computing devices described below with reference to FIG. 10. The user devices 110 may include an operating system and a web browser that are stored in memory and executed on a processor of the user devices 110 or an application that uses data from the mapping service 104 that is stored in memory and executed by the processors of the user devices 110.

Examples of interactive maps that may be displayed by the user devices 110 are illustrated by user interfaces 124 and 126. The user interfaces 124 and 126 may be displayed on a display of the user devices 110 and, in some embodiments, may be interactive. For example, interface 124 illustrates an example of an interactive map. The interactive map of interface 124 may be rendered by a browser of the user devices 110 or may be displayed by a special-purpose application. In this embodiment, the interface 124 is operable to display a map of a geographic area and receive user interactions by which the user requests to view different geographic areas, a subset of the depicted geographic area at a higher resolution or different view, or information about geographically distributed objects.

Users may interact with the interface 124 through a variety of techniques, for example in some embodiments users may click on areas of the map with a mouse, click and drag areas of the map with a mouse, enter text commands with a keyboard, enter verbal commands with a microphone processed by voice recognition, or touch and drag on a single-touch or multi-touch surface of the display to enter commands.

The illustrated interface 124 depict a plan view of a geographic area, for example a satellite view. The interface 124 includes panning commands 128 by which a user may command the interactive map to pan to the East, West, North, or South, and a zoom interface 130 by which a user may move a slider or click buttons to change the extent of the map depicted in the user interface 124. In this embodiment, a search interface 132 may receive text or spoken search requests by a user, for example search queries relating to geographically distributed objects, and a navigation interface 134 may receive text or spoken navigation requests by which a user may request a route between different geographic areas, for example a route for a particular mode of transport, such as by walking, by bicycle, bike car, or by train. A layer interface 136 may receive user requests to overlay the map of the interface 124 with map data, such as traffic data, weather data, photographs, social-networking data, and the like. A view selector interface 138 may receive user requests to view a different view of a geographic area within the interactive map interface 124. For example, a user may click on the view selector interface 138 and drag the view selector interface 138 to a region of the illustrated map in which the user would like to view a eye level view.

In some embodiments, the interface 124 is operable to select a snorkeler eye-level view. For instance, the selector interface 138 may be dragged onto an imaged region of water, or a user may zoom in to an imaged region of water. In response, the user device 110 may receive the request from the user, transmit a request for an snorkeler eye-level view to the mapping service 104, received snorkeler eye-level view interface 126 from the mapping service 104, and display the snorkeler eye-level view interface 126.

The illustrated snorkeler eye-level view interface 126 is an interactive snorkeler eye-level view based upon the images captured and processed with the above-described techniques and stored in the spatial-data store 122. In some embodiments, a user may interact with the interface 126 by clicking, dragging, pressing a button, or otherwise indicating that a user wishes to view within the interface 126 an image of a different direction from a given position, and in response, the user device 110 may display an image in the requested direction, such as an image formed with the above-described stitching process. In some embodiments, images for adjacent directions may be stored in cache in the user device 110, or the user device 110 may request the images corresponding to the selected view from the mapping service 104, for example via the API server 116 or the Web server 114. The interface 126 further includes zoom interface 140 by which a user may request to zoom in or out of the image depicted by the interface 126, and a panning interface 142 by which a user may request images captured from a different position, for example images captured from a different position and stored and processed in accordance with the above-describe techniques. In some embodiments, users may interact with a view-azimuth interface 144 to select a view of an imaged region from a different perspective. For instance, a user may rotate the interface 144 90-degrees to request a view from a camera 26 (FIG. 2) 90-degrees clockwise or counterclockwise relative to the camera from which the present view was captured.

As discussed above, the images presented within the interface 126 may be relatively accurately stitched together, for example with relatively few stitching artifacts, in virtue of some of the above-describe techniques. This should be noted, however, that not all embodiments use the above-describe techniques for the purpose of providing data to a mapping service or for the purpose of stitching images.

In some embodiments, in the course of, as a precondition to, or upon providing panoramas, the map server 118 may be operable to itself, or in combination with another device, determine at least one of the following: whether a user associated with one or more of the user devices 110 has subscribed to a panorama-providing service (e.g., to a service at least partially provided by the map server 118); whether a user associated with one or more of the user devices 110 has a license to view images from the panorama-providing service; or an advertisement to be transmitted to the a user associated with one or more of the user devices 110 based on the requested at least a portion of the panorama. In some embodiments, access to the images may be conditioned upon the result of one or more of these determinations.

FIG. 10 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030 and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area (WAN), a cellular communications network or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include, non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). In some embodiments, the program may be conveyed by a propagated signal, such as a carrier wave or digital signal conveying a stream of packets.

I/O interface 1050 may be configured to coordinate I/O traffic between processors 1010a-1010n, system memory 1020, network interface 1040, I/O devices 1060 and/or other peripheral devices. I/O interface 1050 may perform protocol, timing or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000, or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending or storing instructions or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a”, “an” and “the” include plural referents unless the content explicitly indicates otherwise. Thus, for example, reference to “an element” or “a element” includes a combination of two or more elements, notwithstanding use of other terms and phrases for one or more elements. The term “or” is, unless indicated otherwise, non-exclusive, i.e., encompassing both “and” and “or.” Terms relating to causal relationships, e.g., “in response to,” “upon,” “when,” and the like, encompass both causes that are a necessary causal condition and causes that are a sufficient causal condition, e.g., “state X occurs upon condition Y obtaining” is generic to “X occurs solely upon Y” and “X occurs upon Y and Z.” Similarly, unless otherwise indicated, statements that one value or action is “based on” another condition or value encompass both instances in which the condition or value is the sole factor and instances in which the condition or value is one factor among a plurality of factors. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing or computing device is capable of manipulating or transforming signals, for instance signals represented as physical electronic, optical, or magnetic quantities within memories, registers, or other information storage devices, transmission devices, or display devices of the special purpose computer or similar special purpose processing or computing device.

What is claimed is:

1. A camera for capturing underwater panoramic views from a plurality of image locations along a path and data indicative of orientations and geographic locations of the camera at the image locations, the camera comprising:
a water-proof housing;
an image-capture module disposed at least partially in the water-proof housing and configured to capture a plurality of underwater images of visible light from a plurality of image locations along a path;
a location sensor configured to obtain geographic locations of the plurality of image locations along the path;
an orientation sensor configured to sense orientations of the image-capture module at the plurality of image locations along the path;
memory communicatively coupled to the image-capture module, the location sensor, and the orientation sensor and configured to associate the plurality of underwater images with the orientations of the image-capture and the geographic locations of the plurality of image locations along the path.

2. The camera of claim 1, wherein the image-capture module comprises a plurality of image sensors, each image sensor having an optical axis that is not parallel with the optical axis of the other image sensor or sensors.

3. The camera of claim 2, wherein the image-capture module is configured to orient each of the plurality of image sensors such that each optical axis is at an oblique angle to a surface of water in which images are captured.

4. The camera of claim 2, wherein the image-capture module comprises four image sensors and the optical axis of each image sensor is generally radially symmetrically disposed at approximately 90-degree intervals around a vertical axis substantially normal to a surface of water in which images are captured, and wherein the image-capture module is configured to capture a 360 degree panoramic view.

5. The camera of claim 1, wherein the housing comprises a plurality of discrete housings separate from one another and each discrete housing comprises one of a plurality of image-capture modules.

6. The camera of claim 1, comprising a bubble shield disposed at least partially in an up-stream direction from the image-capture module.

7. The camera of claim 1, comprising a diffuser configured to diffuse sunlight into a region imaged by the image-capture module.

8. The camera of claim 1, comprising:
a plurality of image-capture modules dispersed relative to one another in at least a direction substantially perpendicular to an up-stream direction such that each image-capture module is configured to capture images along one of a plurality of corresponding paths that are generally parallel to the other paths of the other image-capture module or modules; and
an orientation sensor coupled to each of the plurality of image-capture modules.

9. An image-acquisition apparatus, comprising:
an array of two or more water-craft each operable to transport a human operator, each water-craft mechanically coupled to another water-craft in the array of water-craft, and each water-craft having an image-capture module, the image capture module being operable to capture underwater images based on visible light and being operable to capture orientation data indicative of a spatial orientation of at least part of the image-capture module during image capture, each image-capture module comprising:
one or more windows, at least part of which is disposed at a depth under a water-line of the corresponding water-craft;
two or more cameras operable to sense visible light, each camera having an optical axis that intersects at least one of the one or more windows, each optical axis being at an oblique angle to a plane defined by the water-line of the water-craft, and the two or more cameras being approximately radially symmetrically disposed about a normal to the horizontal plane; and
an orientation sensor having zero degrees of freedom relative to the two or more cameras;
at least one of the image-capture modules comprising:
a geographic-position sensor operable to capture location data indicative of a geographic location of the array of water craft, the geographic-position sensor comprising an antenna disposed at least partially above the water-line of the water-craft;
a power-supply operable to provide electrical power to at least one of the image-capture modules; and
one or more processors coupled to a tangible-machine readable memory storing instructions that when executed by one or more of the one or more processors cause each of a plurality of images captured by each image-capture module to be correlated to data from the orientation sensor indicative of orientations of the cameras at the time the image was captured and data from the geographic-position sensor indicative of the geographic location of the array of water-craft at the time the image was captured.

10. A method of imaging an underwater geographic area, the method comprising:
propelling a watercraft through water;
capturing, with one or more cameras coupled to the watercraft, images of underwater features in field of view spanning an approximately 360-degree azimuth;
sensing a geographic location of the watercraft;
sensing an orientation of one or more of the one or more cameras; and
storing the captured images, the sensed geographic location, and the sensed orientation in memory.

11. The method of claim 10, comprising:
associating the captured images with the sensed geographic location and the sensed orientation.

12. The method of claim 10, comprising:
texture mapping the captured images onto a surface, the texture mapping being based on the sensed orientation.

13. The method of claim 10, comprising:
performing a bundle adjustment to the captured images based on the sensed orientation.

14. The method of claim 10, comprising:
calibrating one or more of the one or more cameras by positioning the watercraft such that a reference structure is disposed within a field of view of one or more of the one or more cameras.

15. The method of claim 10, comprising:
shielding a field of view of one or more of the one or more cameras from bubbles in the water.

16. The method of claim 10, comprising:
diffusing sunlight onto an underwater surface in a field of view of one or more of the one or more cameras from bubbles in the water.

17. The method of claim 10, comprising:
propelling a plurality of watercraft approximately in spaced relation through the water;
capturing underwater images from each of the plurality of watercraft.

18. The method of claim 17, comprising:
creating a force with one or more rudders coupled to one or more of the plurality of water craft, the force forcing the plurality of water craft away from one another; and
preventing the watercraft from moving more than a distance away from one another by counteracting the created force.

19. The method of claim 10, comprising:
transmitting the images based on the captured images from a mapping service to a computing device.

20. The method of claim 19, comprising:
determining at least one of the following: whether a user associated with the computing device has subscribed to the mapping service; whether a user associated with the computing device has a license to view images from the mapping service; or an advertisement to be transmitted to the user based on a user request for the transmitted images.
